(19) United States
(12) Patent Application Publication
(10) Pub. No.: US 2006/0249462 A1
(43) Pub. Date: Nov. 9, 2006

(54) EQUIPMENT FOR THE STERILIZATION OF WATER IN BATHROOM FACILITIES AND THE LIKE

(76) Inventor: Pietro CASTELLACCI, Firenze (IT)

Correspondence Address: MCGLEW & TUTTLE, PC, P.O. BOX 9227, SCARBOROUGH STATION, SCARBOROUGH, NY, 10510-9227, US

(21) Appl. No.: 11/381,651

(22) Filed: May 4, 2006

Related U.S. Application Data
(63) Continuation-in-part of application No. PCT/IT04/00605, filed on Nov. 3, 2004.

(30) Foreign Application Priority Data
Nov. 5, 2003 (IT) FI2003A000284

(51) Int. Cl. C02F 1/32

(52) U.S. Cl. 210/748

(57) ABSTRACT

The equipment is installed directly upstream of the delivery outlet; said outlet can be removable and can be reconnectable after sterilization treatment or can be constituted by a disposable nozzle.

The invention relates to equipment to ensure substantial sterilization of the water to be delivered in bathroom facilities in homes, hospitals, various communities and the like.

The invention provides for the use of any type of decontaminant and any sterilization procedure (in particular antibacterial) of water—or other substances—with the use of lamps with light in the ultraviolet range, according to which the lamp or lamps are separated from the space containing the water, or other substance, by a wall in pure polytetrafluoroethylene (PTFE) or another transparent material, which is permeable to the ultraviolet rays, so that the sterilization treatment is ensured and the lamp or lamps are susceptible to easy and infrequent maintenance.

Equipment for the sterilization of water—or other substances—with the use of lamps with light in the ultraviolet range, can comprise a space defined at least in part by a wall made of polytetrafluoroethylene (PTFE) or another transparent material permeable to ultraviolet rays, and in which the water or other substance is contained and/or passes through, and one or more lamps disposed outside said space, so that sterilization is ensured and the lamp or lamps are susceptible to easy maintenance. In a specific solution, the water to be sterilized travels inside one or more tubular walls and one or more tubular lamps with light in the ultraviolet range are disposed outside and around said tubular wall or walls; the lamps can be rectilinear and parallel to the tubular wall or walls, or with annular or helical extension to surround a tubular wall. A reflecting wall can be combined with said lamps.

The equipment forming the object of the invention—for sterilization of water to be delivered to bathroom facilities in homes, hospitals, and various communities—for the functions it requires to perform is installed directly upstream of the delivery outlet, said outlet being removable.

In a possible embodiment, said delivery outlet can be reconnectable after sterilization treatment. In another different and possible embodiment, said delivery outlet can be constituted by a disposable nozzle.

The equipment can be constituted by an assembly which can be associated with a wash basin, a shower or a bidet.

Said assembly can comprise a lamp with light in the ultraviolet range, positioned adjacent to a segment of water pipe, produced in pure polytetrafluoroethylene (PTFE) or another material permeable to ultraviolet rays (crystal, quartz, etc.).

Means can be provided to associate the command to turn on the tap with the command to switch on the lamp or lamps. Advantageously, a system suitable to determine switch-on in advance with respect to delivery can be provided, to ensure sterilization treatment even of the initial jet delivered.

The invention shall be better understood by following the description and accompanying drawing, which shows a non-limiting practical example thereof. In the drawing:

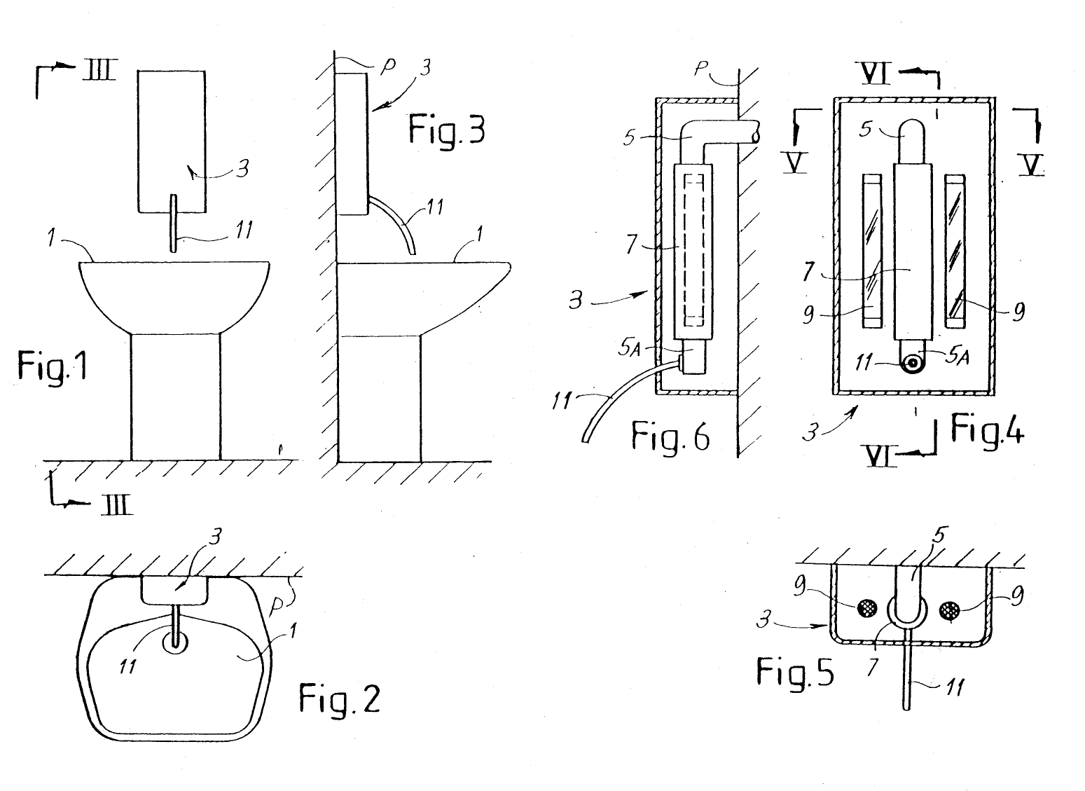

FIGS. 1, 2 and 3 show a front, plan and side view according to the line III-III in FIG. 1 of an installation on a wash basin;

FIGS. 4, 5 and 6 show the assembly in FIGS. 1 to 3 in greater detail, in a front and plan view and in a view according to VI-VI in FIG. 4;

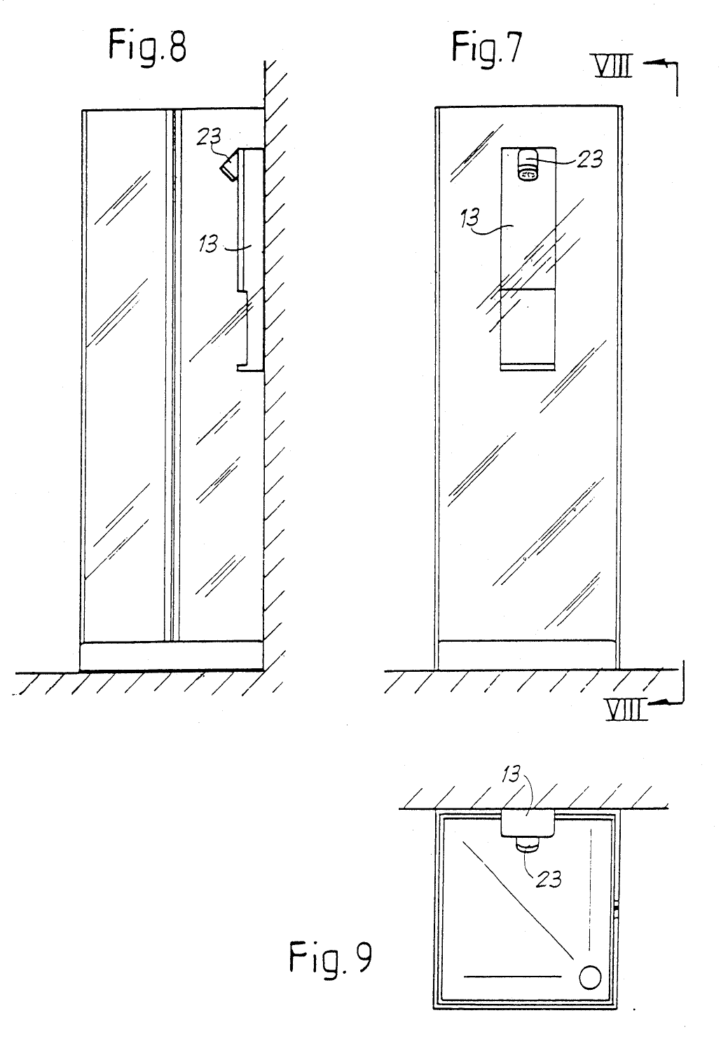

FIGS. 7, 8 and 9 show an installation in a shower, in the front view, in the view according to the line VIII-VIII in FIG. 7 and in a plan view;

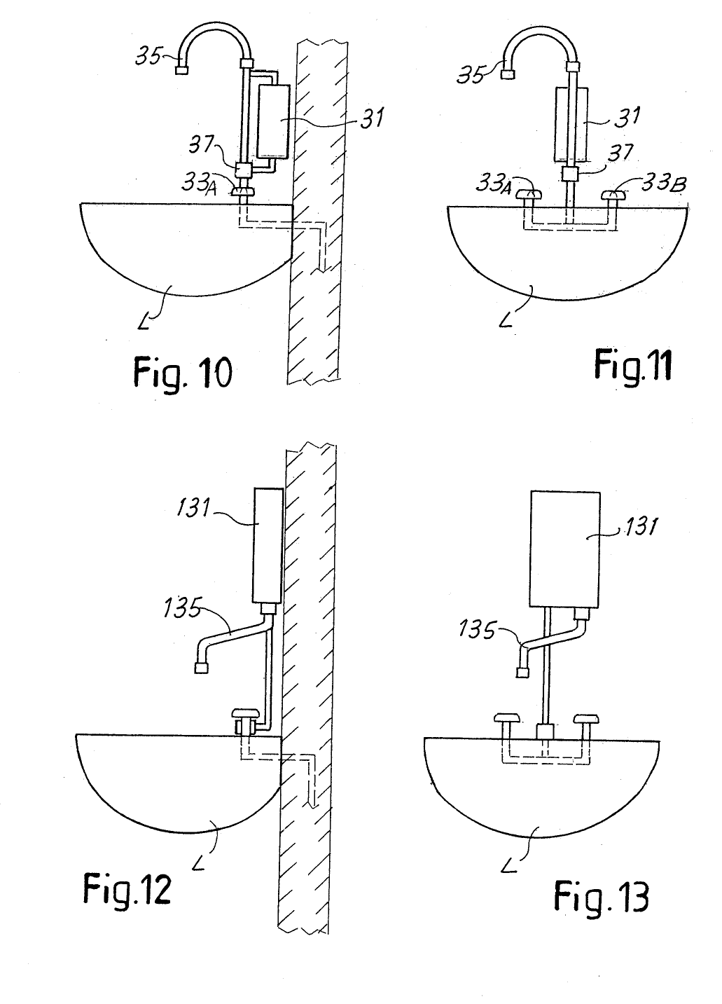

FIGS. 10 and 11; 12 and 13; 14 and 15 show side and front views of schematic applications of equipment with small dimensions to a wash basin and to a shower;

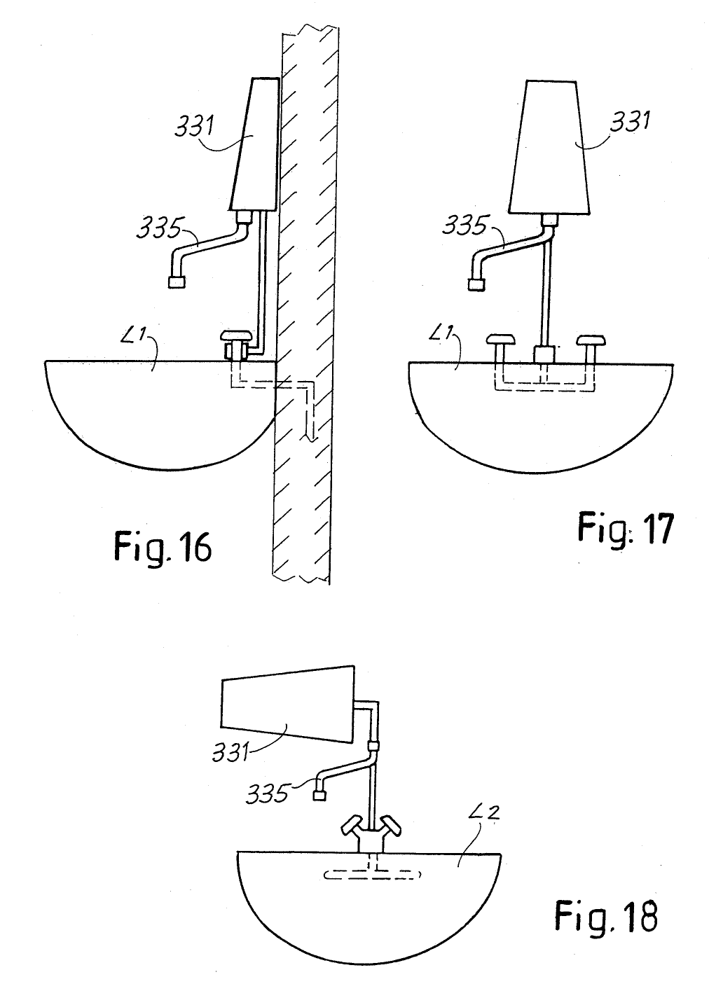

FIGS. 16, 17, 18, 19 and 20 show schematic applications of different equipment to a wash basin and to a shower;

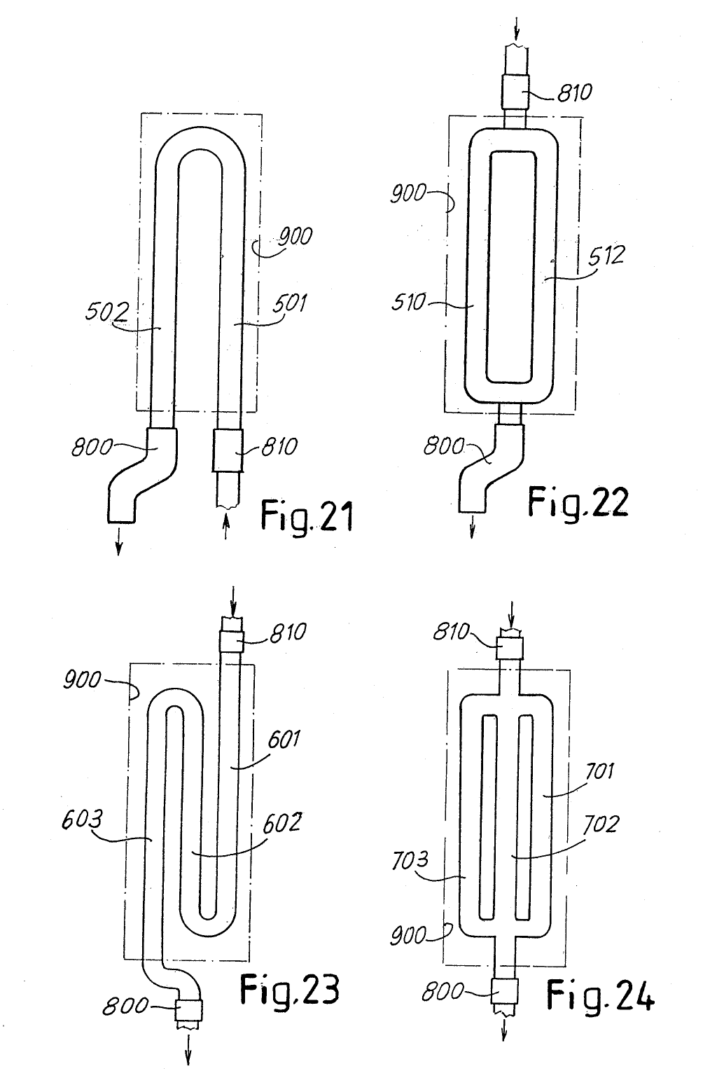

FIGS. 21 to 24 show circuit diagrams of the water in equipment according to the invention; and

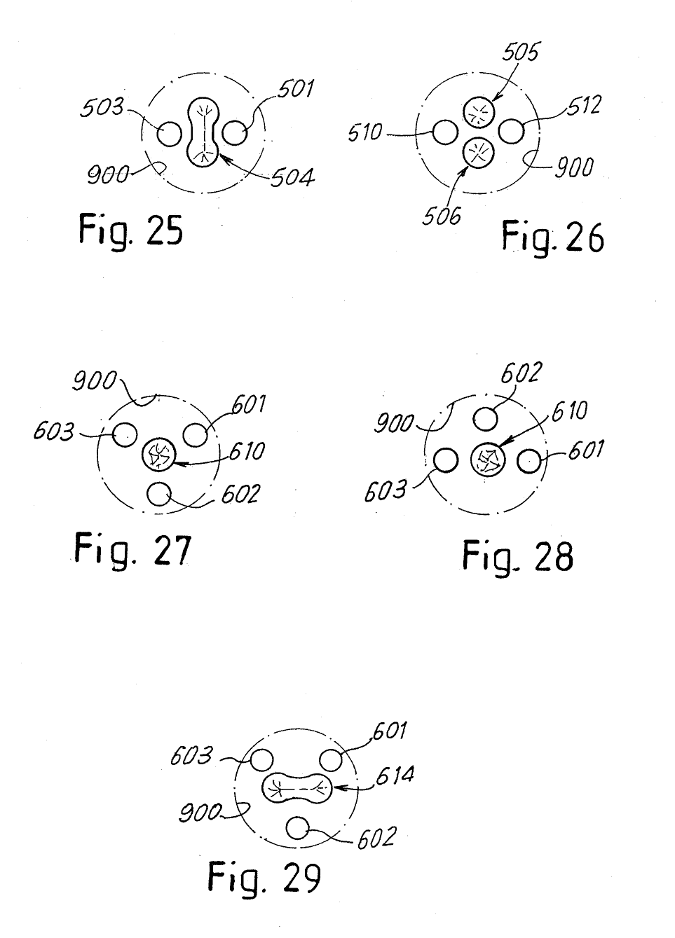

FIGS. 25 to 29 show sectional views of various possible reciprocal positioning of segments of water circuits and of lamps with light in the ultraviolet range.

In FIGS. 1 to 6, the number 1 indicates a wash basin, without the conventional taps; in place of the taps, in a raised position on the wall P is an assembly 3 for sterilization of the water delivered from a pipe 5 destined to supply hot and/or cold water, or water mixed with a regulation system. Appropriate taps upstream of the component—not shown—can be controlled automatically with presence sensors, manually or with a pedal. The pipe 5 comprises a segment 7 transparent to the ultraviolet light delivered from one or more lamps 9 positioned adjacent thereto, to determine sterilization of the water passing therethrough; a suitable increase in the section 7 allows the water passing therethrough to remain for sufficient time to ensure sterilization by the lamps. Downstream of the section 7 the pipe 5A terminates with a fitting for coupling of a nozzle 11, which can be rapidly coupled and removed for sterilization treatment, or as a disposable nozzle.

FIGS. 7 to 9 show an analogous solution for a shower, with an assembly 13 (analogous to the assembly 3), but wherein a removable delivery outlet 21, to be sterilized periodically, can be provided.

The lamps are easily replaceable. The section 7 can be removed for periodic cleaning, which may be infrequent.

When the lamp or lamps are not permanently switched on, a system for suitable delay of delivery with respect to switch on of the lamps can be provided to ensure that the lamps are completely functional when water starts to pass through.

FIGS. 10 and 11 show the application of equipment 31 according to the invention, with small dimensions, to a wash basin L, downstream of the two taps 33A, 33B for hot and cold water; the mixture reaches the equipment 31 and is delivered from the delivery outlet 35, which is replaceable. For cases of emergency, the equipment 31 can be by-passed by a diverter 37, positioned upstream or preferably downstream of the equipment 31.

FIGS. 12 and 13 show an application analogous to the previous one, but with equipment 131 of medium dimensions, and in this case also with a delivery outlet 135 coupled from below to the appliance, and easily removable and replaceable or reconnectable after sterilization.

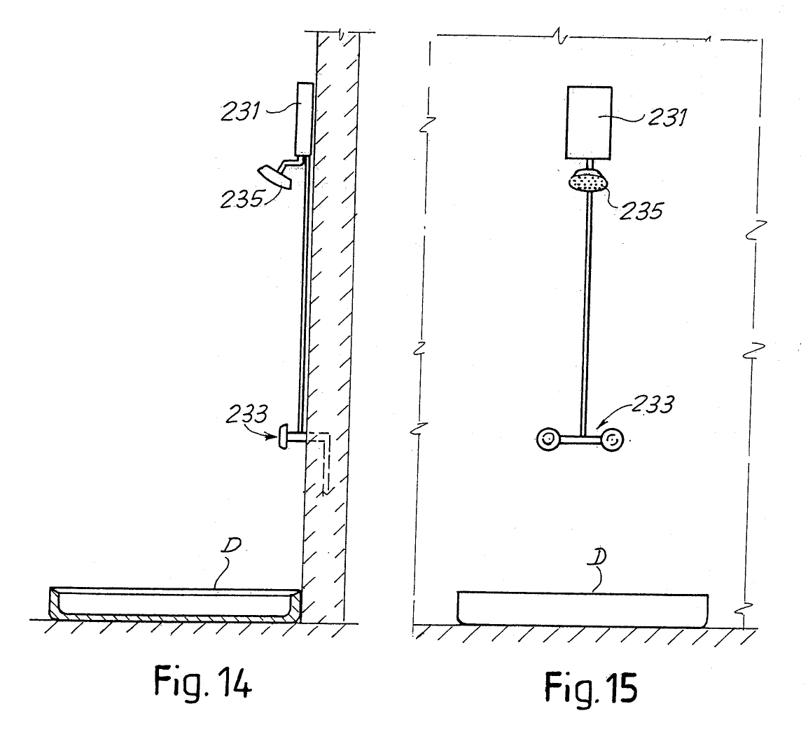

FIGS. 14 and 15 schematically show the application of equipment 231 to a shower D, downstream of the taps 233 and with a delivery outlet 235, also replaceable.

FIGS. 16 to 18 schematically show possible applications of more complex equipment 331 to wash basins L1 and L2, again with a delivery outlet 335 rapidly replaceable or re-usable after sterilization.

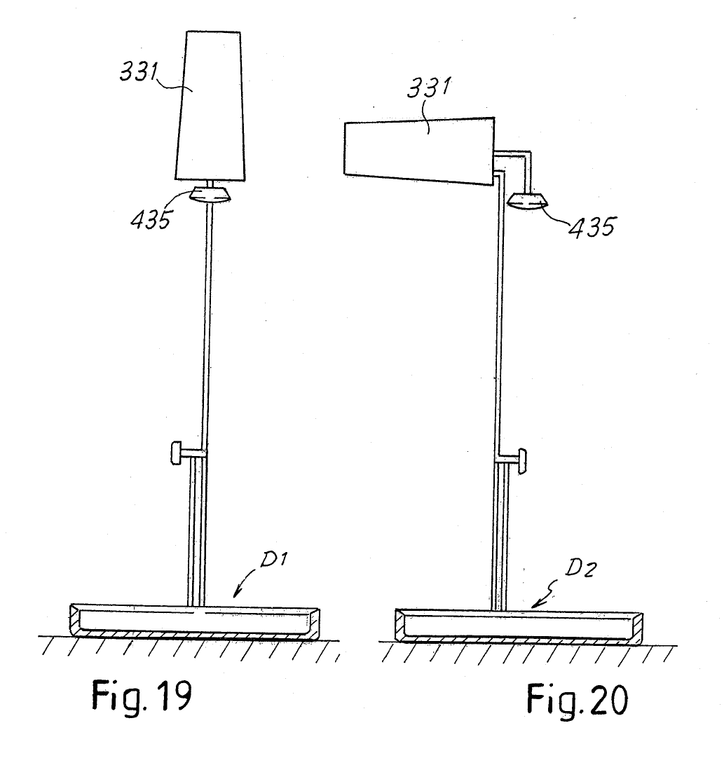

FIGS. 19 and 20 show analogous applications of the equipment 331 to showers D1 and D2, with respective delivery outlet 435 replaceable or re-usable after sterilization.

To ensure that the water being delivered is exposed for sufficient time to the action of the lamps in the ultraviolet range or equivalent, solutions can be adopted such as those indicated schematically in FIGS. 21 to 24 and in FIGS. 25 to 29, with two or more rectilinear segments of the path of the water, parallel to the lamp or lamps. In FIG. 21 two segments of the path 501, 502 in series extend adjacent to a lamp such as the lamp 504 (FIG. 25) or to two lamps 505, 506 (FIG. 26). In FIG. 22 two lamps such as the lamps 505 or 506 (FIG. 26) are positioned adjacent to two segments 510 and 512 in parallel.

In FIG. 23 three segments of the path 601, 602, 603 in series of the water pipe, extend parallel to the lamps, with layouts such as those indicated in FIGS. 27, 28 or 29, with respect to the lamps 610, 612 or 614. Analogously,—as shown in FIG. 24—three segments of path 701, 702 and 703 in parallel can be provided, which can also be positioned as shown, for example, in FIGS. 27, 28 or 29 with respect to the lamps.

In FIGS. 21 to 24 the number 800 indicates delivery outlets, replaceable or removable to be sterilized. The number 810 indicate solenoid valves, which can be provided to automatically shut off delivery of water, in the event of faulty operation of the lamps. Means to indicate faults or irregular functioning can also be provided.

The equipment, as schematized in FIGS. 21 to 29 or equivalent, can be provided with reflecting walls 900, which surround the paths of the water and the lamps, to ensure irradiation of the water pipes permeable to direct or reflected ultraviolet light, and to exclude emission of this light towards the outside.

It is understood that the drawing only shows an example provided purely as a practical embodiment of the invention, as said invention may vary in forms and layouts without however departing from the scope of the concept on which the invention is based.

1. Equipment for the sterilization, in particular antibacterial, of water to be delivered in bathroom facilities in homes, hospitals and various communities, with at least one lamp with light in the ultraviolet range, having a linear extent, characterized in that it comprises at least two lamps, which are external and positioned adjacent to at least one segment of water pipe, said equipment being installed directly upstream of a delivery removable outlet.

2. Equipment as claimed in claim 1, characterized in that the lamps are adjacent to at least two segments of pipe, which are arranged for water circulation.

3. Equipment as claimed in claim 2, characterized in that the segments of water pipe are in parallel.

4. Equipment as claimed in claim 2, characterized in that the segments of water pipe are in series.

5. Equipment as claimed in claim 1, characterized in that said delivery outlet can be reconnected after sterilization treatment.

6. Equipment as claimed in claim 1, characterized in that said delivery outlet is constituted by a disposable nozzle.

7. Equipment as claimed in claim 2, characterized in that said segments of path and the lamps with ultraviolet light are housed inside a reflecting wall.

8. Equipment as claimed in claim 1, characterized in that it comprises a solenoid valve suitable to shut off delivery of water in the event of faulty operation of the lamps.

9. Equipment as claimed in claim 2, characterized in that said section or sections of water pipe are produced in pure polytetrafluoroethylene (PTFE) or another material permeable to ultraviolet rays.

10. Equipment as claimed in claim 1, comprising means to associate the command to turn on the tap with we command to switch on the lamp or lamps, with a system suitable to determine switch-on in advance with respect to delivery.

11. Equipment as claimed in claim 1, characterized in that it is constituted by an assembly which can be associated with a wash basin.

12. Equipment as claimed in claim 1, characterized in that it is constituted by an assembly which can be associated with a shower.

13. Equipment as claimed in claim 1, characterized in that it is constituted by an assembly which can be associated with a bidet.
